(19) United States
(12) Patent Application Publication
(10) Pub. No.: US 2009/0205922 A1
(43) Pub. Date: Aug. 20, 2009

(54) Synchronizer ring with a fiber-reinforced, organic friction lining, and method for the production thereof

(76) Inventor: Christof Eberspacher, Esslingen (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 12/380,987

(22) Filed: Mar. 5, 2009

Related U.S. Application Data
(63) Continuation-in-part of application No. PCT/EP2007/007777, filed on Sep. 6, 2007.

(30) Foreign Application Priority Data
Sep. 9, 2006 (DE) 10 2006 042 442.5

(51) Int. Cl. F16D 23/04; B32B 37/12

(52) U.S. Cl. 192/66.2; 156/256

(57) ABSTRACT

In a synchronizer ring including a fiber-reinforced, organic friction lining adhesively bonded to a conical surface area thereof, the friction lining is cut out of a flat sheet of organic friction material in the form of a number of strips which are curved in accordance with the shape of a development of the conical surface area of the synchronizer ring, the curved strips having the same general curvature at their inner and outer edges, the inner and outer edges having shapes such that the inner and outer edges are translationally congruent that is the shapes of the edges of adjacent strips are identical and the strips can be accommodated in side-by side relationship on the flat sheet thereby reducing cutting efforts and material waste.

This is a Continuation-In-Part application of pending international patent application PCT/EP2007/007777 filed Sep. 6, 2007 and claiming the priority of German patent application 10 2006 042 442.5 filed Sep. 9, 2006.

### BACKGROUND OF THE INVENTION

The invention relates to a synchronizer ring including a fiber-reinforced, organic friction lining adhesively bonded to it and to a method for producing a plurality of friction linings for synchronizer rings of this type.

A clutch body with a fiber-reinforced, organic friction lining adhesively bonded to it is disclosed in U.S. Pat. No. 5,858,511. A clutch body of this type is used for mechanical synchronization. The friction lining has grooves which are already incorporated in a sheet of the friction lining material. A strip in the form of a development of a truncated cone is cut from the sheet to be adhesively bonded to the conical clutch body. The grooves extend on the sheet in parallel alignment.

It is the principle object of the invention to provide an inexpensive synchronizer ring including a friction lining adhesively bonded thereto.

### SUMMARY OF THE INVENTION

In a synchronizer ring including a fiber-reinforced, organic friction lining adhesively bonded to a conical surface area thereof, the friction lining is cut out of a flat sheet of organic friction material in the form of a number of strips which are curved in accordance with the shape of a development of the conical surface area of the synchronizer ring, the curved strips having the same general curvature at their inner and outer edges, the inner and outer edges having shapes such that the inner and outer edges are translationally congruent that is the shapes of the edges of adjacent strips are identical and the strips can be accommodated in side-by side relationship on the flat sheet thereby reducing cutting efforts and material waste.

In this context, material cut-outs are provided at the inner and/or the outer edges of the friction lining. These material cut-outs may be, in particular, corrugation valleys of a corrugated edge structure. Other edge shapes such as, for example, a quadrilateral or triangular toothing are, however, also possible. The advantage of the corrugated form is that stress peaks are avoided in the material; i.e. the stress is uniformly distributed.

If friction lining strips are cut out of a sheet of friction material always, a protruding strip region disposed between material cut-out regions may be disposed in a material cut-out region of another strip on the sheet. This allows optimum utilization of a sheet of friction material. In one particularly advantageous embodiment of the invention, the inner edge of one strip is congruent with the outer edge of a different strip on the sheet. This keeps the amount of waste small and the cutting time short.

The recesses may serve as an oil feed structure for supplying oil to the fiber-reinforced, organic friction lining and for carrying it away again.

Since the recesses inevitably weaken the material, the synchronizer rings may be used, in particular, with small gear mechanisms whose synchronizer rings are in the form of a multi-synchronization mechanism purely for reasons of comfort. Multi-synchronization mechanisms of this type are, in particular, the double- and triple-synchronization mechanisms. The synchronizer rings may even be used with heavy gear mechanisms, in particular, with front-mounted group synchronization mechanisms which are subjected to small loads.

The invention will become more readily apparent from the following description of exemplary embodiments thereof on the basis of the accompanying drawings.

### BRIEF DESCRIPTION OF THE DRAWINGS

FIG. 1 shows a synchronizer clutch body with a friction lining and a corresponding synchronizer ring with a corresponding friction surface,

FIG. 2 shows, in a developed view, a strip of the friction lining shown in FIG. 1,

FIG. 3 shows a sheet of friction material with the cutting pattern for a plurality of strips according to FIG. 2,

FIG. 4 shows an alternative embodiment of a strip of a friction lining, and

FIG. 5 shows a sheet of friction material with the cutting pattern for a plurality of strips according to FIG. 4.

### DESCRIPTION OF EXEMPLARY EMBODIMENTS

FIG. 1 shows a clutch body 1 with a friction lining 2a. It also illustrates a corresponding synchronizer ring 3 with a corresponding friction face 4.

The clutch body 1 includes a truncated cone section 5 or has a conical shape. The friction lining 2a is adhesively bonded to this truncated cone section 5 so as to extend all around it. The ends 6, 7 on the face of the friction lining 2a are adhesively bonded to one another in abutting fashion. The two long edges—that is to say an inner edge 8 and an outer edge 9—of the friction lining 2a have a corrugated form and therefore material recesses 10, 11 are produced in the corrugation valleys. The friction lining 2a here consists of a carbon-fiber fabric as is known, for example, from U.S. Pat. No. 5,662,993. In a first method step, the fabric is filled with a resin which, in a subsequent pyrolytic process, is cleaved to form primarily carbon. At the surface of the friction lining, the fibers are exposed and protrude slightly. Small depressions for holding oil and elevations are therefore formed in the fabric. This oil serves for cooling and lubricating and is conducted via the material recesses 10 and 11 mentioned in the back and forth in the recesses 11 and 10. The material recesses therefore ensure a constant flow of oil through the friction lining 2a.

It can be seen in FIGS. 2 and 3 that the material cut-outs 10 and 11 also permit virtually optimal utilization of a sheet 12 with friction material out of which the strip 2b in the form of a lateral face of a truncated cone is cut in order to produce the friction lining 2a.

To this end, a plurality of strips 2b are cut out of a sheet 12, wherein corrugation peaks 13 of the corrugated outer edges 9 extend in to the corrugation recesses or cut-outs 10 of the inner edges 8. However, the fact that the strips 2b are in the form of a development of a truncated cone means that the inner edge 8 is not exactly complementary to the outer edge 9. It is therefore necessary to cut out each strip 2b with its own contour.

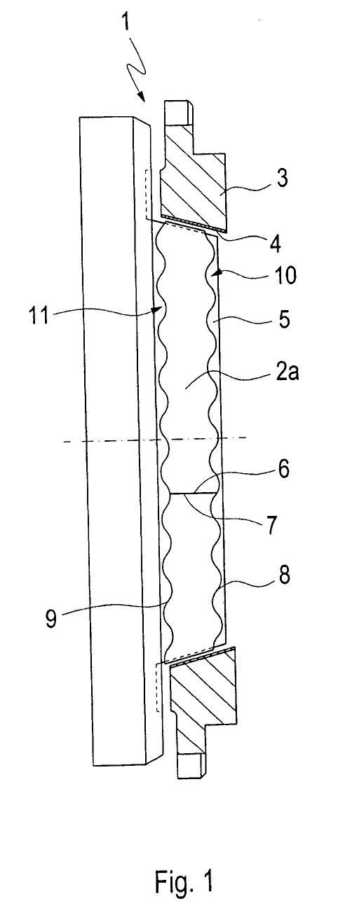

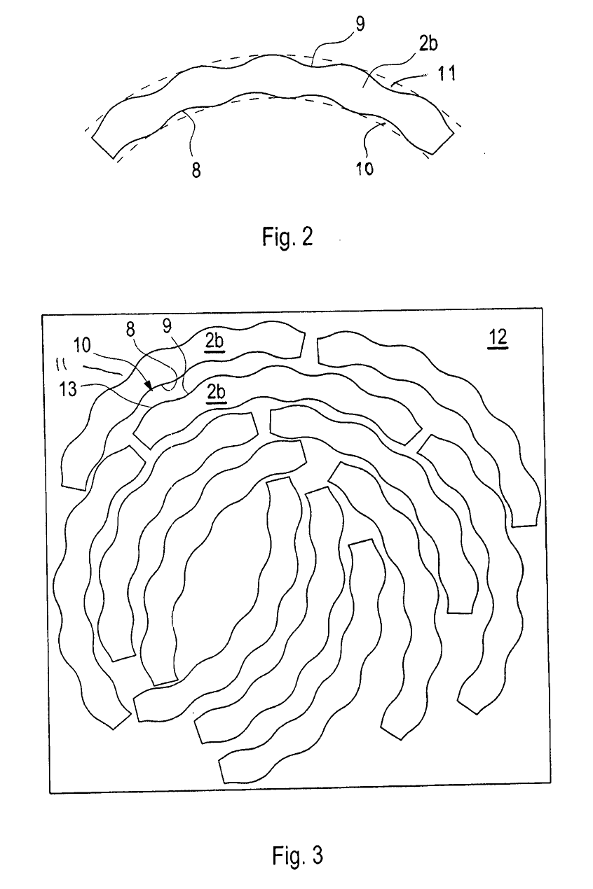

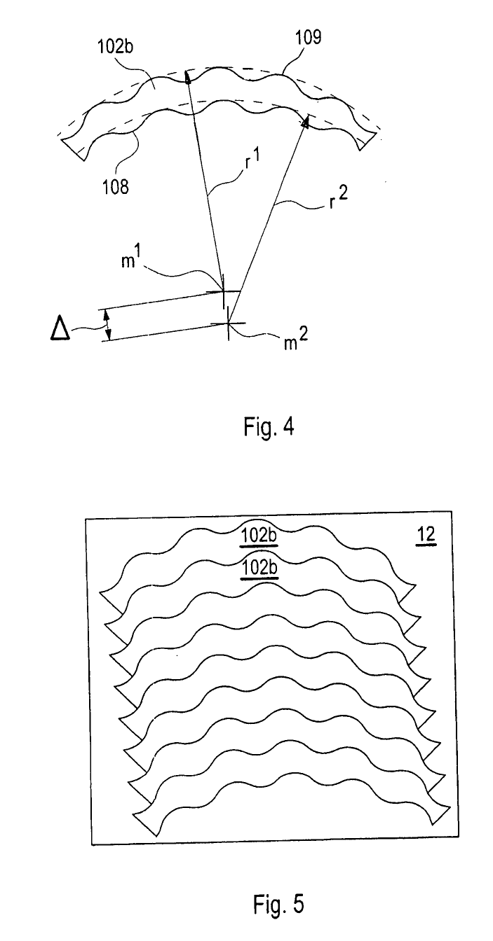

By contrast, FIGS. 4 and 5 show a shape of the strip 102b in which the radius r1 of the outer edge 109 is equal to the radius r2 of the inner edge 108. In this context, the midpoints m1, m2 of the two radii r1, r2 are offset by a quantity A with respect to one another. As a result, according to FIG. 5, it is possible for the inner edges 108 to be at least partially congruent with the outer edges 109 wherein however the recesses and projection are circumferentially somewhat displaced. The number of cuts required for cutting out the strips 102b can therefore be reduced to a minimum. This reduces the cutting time. The amount of waste is also minimized in this way.

The sheet may be subjected to a minimum degree of grinding before the strips are cut out. The fiber protrusions of the fabric are ground down only slightly so that a uniform maximum thickness level is formed.

What is claimed is:

1. A synchronizer ring (1) having a conical annular surface area with a fiber-reinforced, organic friction lining (2a) adhesively bonded to the annular surface of the synchronizer ring (1), said friction lining being formed by flat strip sections curved in accordance with a development of a conical synchronizer ring section and having inner and outer opposite side edges (8, 9) with recesses (10, 11) formed at opposite sides of the curved strip sections shaped so as to be translationally congruent.

2. The synchronizer ring as claimed in claim 1, wherein the recesses (10, 11) at the opposite inner and outer side edges (8, 9) of the friction lining (2a) are spaced over the length of the side edges.

3. The synchronizer ring as claimed in claim 2, wherein the side edges of the friction lining (2a) are corrugated and the recesses (10, 11) are corrugation valleys.

4. The synchronizer ring as claimed in claim 1, wherein the synchronizer ring is a multi-cone synchronizer ring.

5. A method for producing a plurality of friction linings for synchronizer rings having a conical annular surface area with a fiber-reinforced, organic friction lining (2a) adhesively bonded to the surface of the synchronizer ring (1), said lining having said method comprising the steps of: cutting a plurality of strips (2b) out of a flat sheet (12) of fiber-reinforced, organic friction material for each friction lining (2a) in a curved shape as formed by a development of the conical annular surface area, the strips (2b) having opposite side edges (8, 9) which are translationally congruent so as to have an identical cutting line .

6. The method as claimed in claim 5, wherein each cut extends generally along a circle section having the same radius but includes side recesses, (10, 11) and extensions so as to form corrugated longitudinal inner and outer side edges (8, 9), the recesses of (108) of each friction lining strip (102b) is congruent with the inner and outer edges (109) of adjacent friction lining strips (102b) as cut from the flat sheet (12).

7. The method as claimed in claim 6, wherein the flat sheet (12) of fiber-reinforced, organic friction material comprises a fabric which has previously been impregnated with a resin that is pyrolytically cleaved in a subsequent method step to form primarily carbon, wherein thread areas form on the flat sheet surface alternately projections projecting from the surface and depressions in which oil can accumulate.

8. The method as claimed in claim 6, wherein the outer edge and the inner edges have centers of curvature which are spaced by a distance (Δ) with respect to one another corresponding to the width of the friction material strips (102b) and the radii (r1, r2) of the curvature have the same length.

9. The method as claimed in claim 6, wherein the inner edge (108) of a friction lining strip (102b) coincides on a friction material sheet with the outer edge (109) of an adjacent friction lining strip so that the inner and outer edges (108,109) of the adjacent friction lining strips (102b) are cut with a single cutting step.
